(19) United States
(12) Patent Application Publication
(10) Pub. No.: US 2021/0169241 A1
(43) Pub. Date: Jun. 10, 2021

(54) WALL ANCHORING ASSEMBLIES FOR HEAVY OBJECTS

(71) Applicant: 3M INNOVATIVE PROPERTIES COMPANY, St. Paul, MN (US)

(72) Inventors: Archie F. Hamel, Taylor's Falls, MN (US); Kacie M. Hynnek, Inver Grove Heights, MN (US); Bryan A. Berger, East Windsor, NJ (US); Tatiane Dias Marques Faria, Lake Elmo, MN (US); Joseph A. Hoffman, Minneapolis, MN (US); Jacob R. Thieschafer, Coon Rapids, MN (US)

(21) Appl. No.: 17/052,276

(22) PCT Filed: May 1, 2019
(86) PCT No.: PCT/IB2019/053565

§ 371 Date: Nov. 2, 2020

Related U.S. Application Data
(60) Provisional application No. 62/665,967, filed on May 2, 2018.

(51) Int. Cl. A47G 1/16; A47G 1/20; A47G 1/22; A47G 1/17; F16B 15/00

(52) U.S. Cl. CPC A47G 1/1633; A47G 1/202; F16B 2015/0076; A47G 1/175; F16B 15/0023; A47G 1/22

(57) ABSTRACT

The present disclosure provides several anchor assemblies for hanging or otherwise securing an object to a wall, particularly those with wallboards including gypsum. The assemblies include a frame and an insert that cooperate to provide a mounting surface. At least one of the frame and insert include one or more prongs for penetrating wallboard. The anchor can be secured to and removed from the wall with relative ease, while causing minimal damage to any punctured wallboard.

### BACKGROUND

Numerous products and devices exist for installing a hook or hanging device in a wall, such as for hanging a picture frame, a mirror, or the like. Conventional nails and screws are not always convenient solutions and may not provide sufficient support strength in the wall, particularly in the case of drywall, or other friable wallboards, which are relatively weak. Other hanging devices may avoid the use and attendant drawbacks of conventional fasteners, but nonetheless may result in excessive damage to the wallboard, require the use of conventional tools, or fail to consistent hold the desired weight.

SUMMARY

The present inventors discovered that both installation and stability of wall hanging system may be considerably improved by relying on systems consisting of independent, cooperating components. The wall anchor assemblies of the present disclosure include a frame and a distinct insert plate. The frame includes one or more prongs that can be inserted into wallboard using light to moderate finger pressure. The insert plate is received in a recess or other guide on or defined by the frame. The insert plate includes a load bearing structure that allows for mounting of myriad objects. Use of a distinct frame renders the prongs easier to insert into the wallboard, while the insert can provide adjustability to the location and orientation of the object to be mounted. The insert can also be disengaged from the frame prior to removal of the assembly from the wall surface, easing removal of the prongs from the wallboard or other wall material. The present disclosure thus provides a wall anchor that can be easily applied manually on drywall and causes reduced or minimal damage upon removal. The assemblies herein can provide a faster and easier way of hanging a heavy weight object, such as large picture frames and mirrors over 25 or 50 pounds.

In one aspect, the present disclosure provides a wall anchor assembly for attaching to a mounting surface. The assembly comprises a frame plate having a front surface and a back surface; the frame plate including a recess; a first prong extending outwardly from the back surface of the frame; and an insert receivable within the recess, the insert including a load bearing structure extending a least partially in the opposite direction of the prong.

In another aspect, the present disclosure provides a wall anchor assembly for attaching to a mounting surface. The assembly comprises an insert plate having a front surface and an opposing back surface and defining a perimeter, the back surface including an adhesive construction; a frame dimensioned to surround the perimeter of the base plate, wherein the frame includes a recess, and wherein a portion of the insert plate is dimensioned to fit within the recess.

As used herein, “layer” means a single stratum that may be continuous or discontinuous over a surface.

As used herein “geometry” refers to the size and shape of an element.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a”, “an”, and “the” are not intended to refer to only a singular entity, but include the general class of which a specific example may be used for illustration. The terms “a”, “an”, and “the” are used interchangeably with the term “at least one”. The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and preferably by the term “exactly”. As used herein in connection with a measured quantity, the term “about” refers to that variation in the measured quantity as would be expected by the skilled artisan making the measurement and exercising a level of care commensurate with the objective of the measurement and the precision of the measuring equipment used.

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

The disclosure will be further described with reference to the drawings, wherein corresponding reference characters indicate corresponding parts throughout the several views, and wherein:

FIG. 1 illustrates a perspective view of a wall anchor assembly, according to one embodiment of the present disclosure;

FIG. 2 is a top view of the wall anchor assembly of FIG. 1;

FIG. 3 is a front planar view of the wall anchor assembly of FIGS. 1 and 2;

FIG. 4 is a side-view of the wall anchor assembly of FIGS. 1-3 secured to a wall surface;

FIG. 5 is an exploded, front perspective view of the wall anchor assembly of FIGS. 1-4;

FIG. 6 is an exploded, rear perspective view of the wall anchor assembly of FIGS. 1-4;

FIG. 7 illustrates a perspective view of a wall anchor assembly, according to another embodiment of the present disclosure;

FIG. 8 is a side-view of the wall anchor assembly of FIG. 6.

FIG. 9 is a perspective view of a frame for use in the wall anchor assembly of FIGS. 6-7;

FIG. 10 is a perspective view of an insert plate for use in the wall anchor assembly of FIGS. 6-7;

FIG. 11 illustrates a perspective view of a wall anchor assembly, according to yet another embodiment of the present disclosure;

FIG. 12 illustrates a top view of the wall anchor assembly of FIG. 10;

FIG. 13 is a front planar view of the wall anchor assembly of FIGS. 10 and 11;

FIG. 14 is a side-view of the wall anchor assembly of FIGS. 10-12;

FIG. 15 is an exploded, front perspective view of the wall anchor assembly of FIGS. 11-14; and

FIG. 16 is an exploded, rear perspective view of the wall anchor assembly of FIGS. 11-14.

Layers in certain depicted embodiments are for illustrative purposes only and are not intended to absolutely define the thickness, relative or otherwise, or the absolute location of any component. While the above-identified figures set forth several embodiments of the disclosure other embodiments are also contemplated, as noted in the description. In all cases, this disclosure presents the invention by way of representation and not limitation. It should be understood that numerous other modifications and embodiments can be devised by those skilled in the art, which fall within the scope and spirit of the principles of the invention.

### DETAILED DESCRIPTION OF ILLUSTRATIVE EMBODIMENTS

While the above-identified figures set forth several embodiments of the disclosure other embodiments are also contemplated, as noted in the description. In all cases, this disclosure presents the invention by way of representation and not limitation. It should be understood that numerous other modifications and embodiments can be devised by those skilled in the art, which fall within the scope and spirit of the principles of the invention.

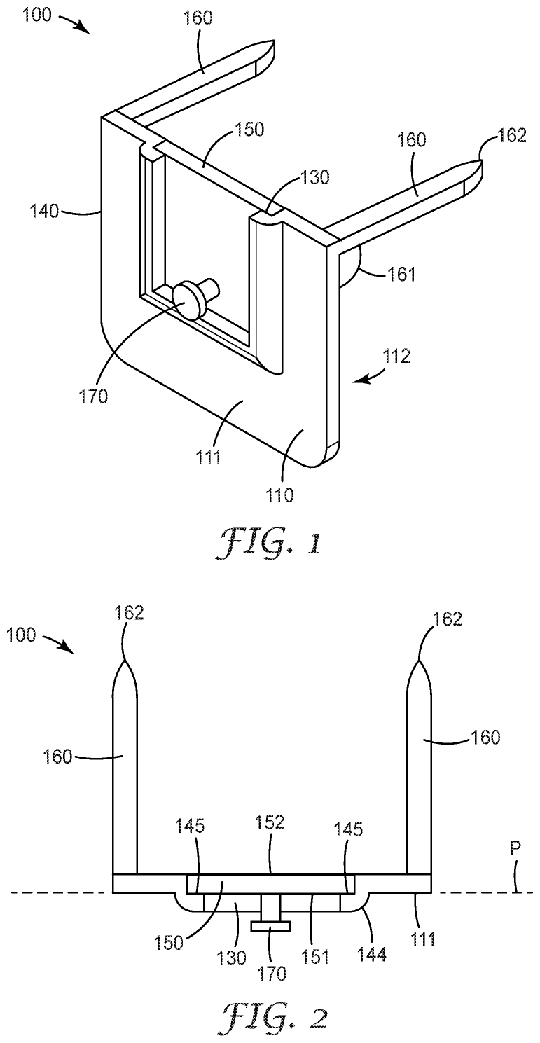

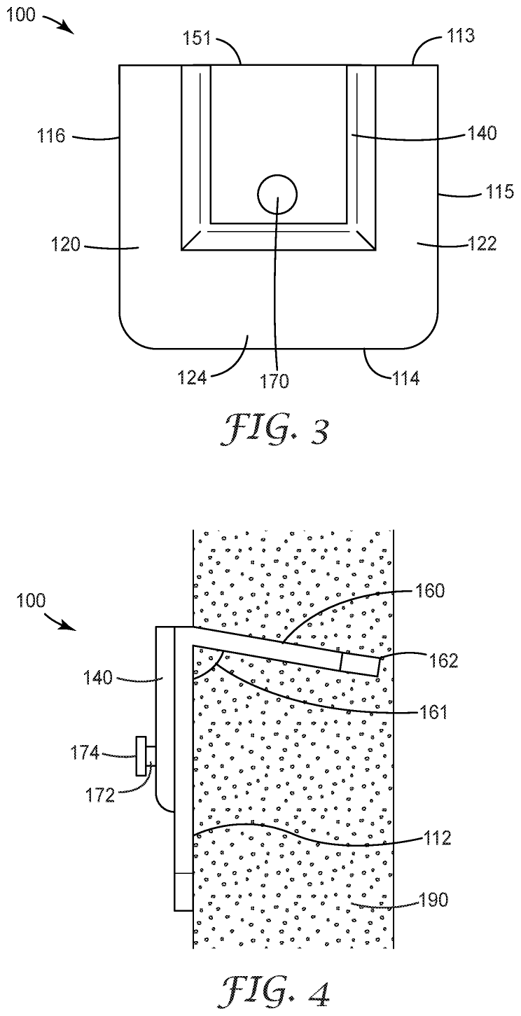

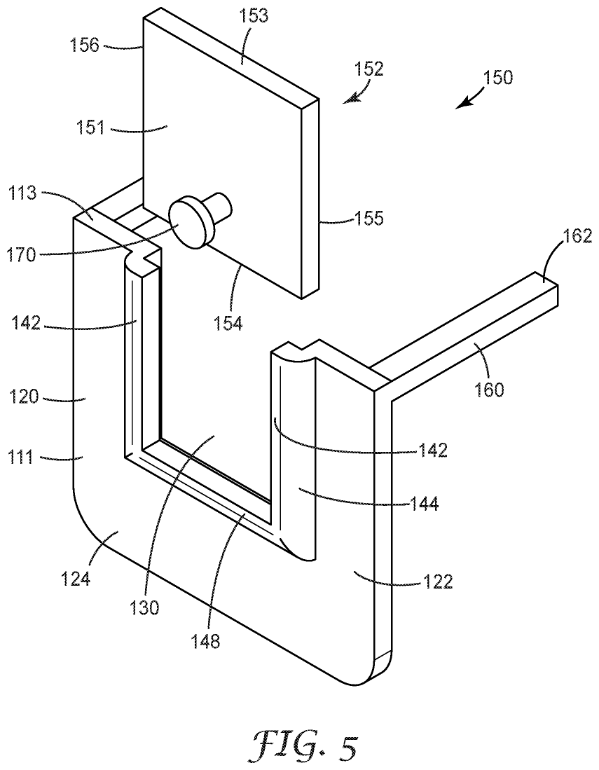

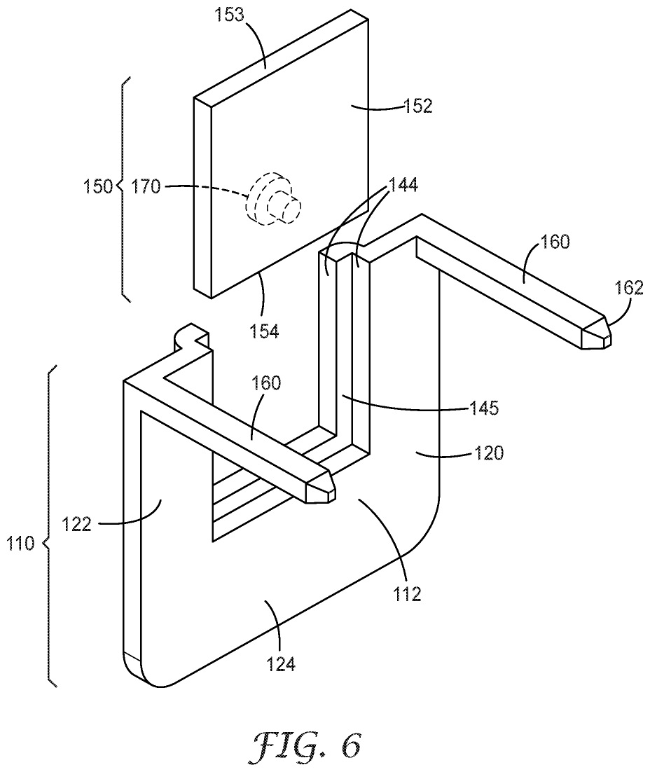

A wall anchor assembly 100 according to one embodiment of the present disclosure is depicted in FIGS. 1-6. The wall anchor 100 includes a frame plate 110 and a moveable insert 150 received in a recess 130 defined in the frame 110. When assembled and as depicted in FIG. 3, the anchor 100 presents a generally rectangular shape. The frame 110 includes a front surface 111 opposing a back, wall-facing surface 112, a top edge 113, a bottom edge 114, and opposing side edges 115, 116 connecting the top and bottom edges 113, 114 to define an outer frame perimeter. A pair of prongs 160 extend outwardly from the top edge 113 at an angle 161 with respect to the back surface 112 (e.g., see FIG. 3). The prongs 160 extend to an outer end 162 that can be tapered to ease insertion when pressed into wall board.

The frame 110 has an overall, generally “U”-shaped configuration, though other configurations such as “V”-shaped or “C”-shaped are possible. The frame 110 includes a first section 120 and a second section 122 that is opposed to the first section 120. The first section 120 and the second section 122 extend in generally parallel directions. The first section 120 is spaced apart from the second section 122 to present an open-ended region or recess 130 for receiving the insert 150. The recess 130 generally corresponds in at least the width dimension to the width of the insert 150. The frame 110 further includes a third section 124 that interconnects the first section 120 and the second section 122; the sections 120, 122, and 124 are typically coplanar and include front surfaces residing in a plane “P”.

As depicted in FIGS. 1-6, the recess 130 is generally rectangular when viewed in a plane perpendicular to the frame plane “P”. In alternative embodiments, however, the recess may take on another shape or shapes, including circular, ovular, triangular tetrahedral, Y-shaped, etc. Though the recess 130 is depicted as generally matching the shape of the anchor 100 as assembled (e.g., FIG. 3), this correspondence is not necessary. For instance, the recess 130 may include an ovular shape when viewed in a plane perpendicular to the frame plane “P”, while the anchor 100 presents an overall rectangular shape. Other variations are contemplated and discernable by those of skill in the art.

A guide 140 surrounds the periphery of the recess 130 and includes opposing rails 142 integral with the first and second sections 120, 122, and third rail 148 extending along the bottom of the recess 130 on the third section 124. The rails 142 are coupled to the respective section of the frame via a guidewall 144, which is arranged substantially perpendicular to the frame plane “P”. Each rail 142 is spaced from the frame plane “P” according to the height of the guidewall 144, which generally corresponds to a thickness of the insert 150.

The rails 142 serve to accept and guide the insert into the bottom of the recess, while the bottom rail 148 acts a stop surface or detent to arrest sliding of the insert 150 in the direction of the bottom edge 114. As depicted, each rail 142 extends the full length of the recess 130 to the top edge 113 of the frame, while the bottom rail 148 extends the full width thereof. In other embodiments, any or all rails may extend only a portion of the recess dimensions; in particular, the third rail 148 may be centrally located on the third section, and may not connect to either or both the side rails 142.

The rails 142 and 148 extend over and into the recess 130, forming an overlay surface 145 facing the frame plane “P”. The overlay surface 145 limits or prevents rotational movement of the insert 150 about an axis coincident with a loading bearing projection 170 when the anchor is assembled, as well as operating to aid the placement of the insert 150 within the recess 130. As one skilled in the art can appreciate, there may be appropriate tolerances between the rails 142 and the dimensions of the insert to facilitate sliding of the insert 150 and avoid binding The spacing of the overlay surfaces 145 also allows a front surface 151 of the insert 150 to reside in or directly adjacent the frame plane “P”, allowing the back surface 112 of the frame to remain generally flush with the wall.

Both the first and second frame sections 120, 122 include a prong 160 coincident with the upper edge 113 and respective side edges 115, 116 of the frame 110. The prongs 160 extend to an outer end point 162 over a length that is generally equal to or less than the thickness of the wallboard to which the anchor would typically be attached. The lengths of the prongs can be varied to allow selection for a specific thickness of wallboard.

As previously described, the prong 160 forms an angle 161 with the back surface 112 of the frame. By way of example, angle 161 (e.g., taken relative to a plane parallel to the frame plane “P”) may be between about 75 degrees and about 90 degrees (such as between about 80 degrees and about 90 degrees or between about 85 degrees and about 90 degrees), though variations are possible. In presently preferred implementations, the prongs 160 extend generally along a plane that is substantially orthogonal to the frame plane “P”. Without wishing to be bound by theory, providing an excessively acute between the prong 160 and the back surface 115 tends to shear gypsum wall board. A slightly acute angle (e.g., an angle 161 of 80 degrees or greater), however, may ease insertion of the anchor 100 and assist in drawing both the frame 110 and insert 150 substantially parallel to the wall board in certain embodiments.

The prongs 160 may include one or more flat surfaces and may comprise different cross-sectional shapes and combination of shapes (e.g., rectangular, circular, ovular, triangular etc.). For instance, an upper surface of a prong may be rounded, with a planar bottom surface to prevent crack propagation in the wallboard. The prongs 160 can taper over all or a portion of the length between the back surface 112 and the outer end 162. In the illustrated embodiment, and as can be seen particularly clearly from FIGS. 1, 2, and 5, the prongs 160 can be formed from a monolithic piece of material that has been bent or otherwise articulated to form both frame sections 120, 122 and prongs 160. Thus, the prongs 160 include at least one section that is integral and coplanar with the top edge 113 of the frame 110. In other embodiments, the prongs may be soldered, welded, or otherwise attached to the back surface 112 of the frame 110 at an edge or other location spaced from the recess 130.

Like the frame 110, the insert 150 includes the front surface 151 opposing a back, wall-facing surface 152, a top edge 153, a bottom edge 154, and opposing side edges 155, 156 connecting the top and bottom edges 153, 154 to define an outer insert perimeter. The insert 150 further includes a thickness 157 that generally corresponds to the height of the guide walls 144, at least in areas proximate the side edges 155, 156. As depicted in FIGS. 1-6, the insert 150 is generally rectangular when viewed in a plane perpendicular to the frame plane “P”. In alternative embodiments, however, the insert 150 may take on another shape or combination of shapes, including circular, ovular, triangular, tetrahedral, Y-shaped, etc. Though the insert 150 is depicted as generally matching the shape of the anchor 100 and the recess 130, such correspondence is not strictly necessary.

A load bearing projection 170 extends outward from the front surface 151 of the insert 150. The load bearing projection 170 is depicted as including a shaft 172 and cap 174, similar to that of a conventional nail. The insert 150 may instead feature a hook, a ledge, a shank, or any number of load bearing structures used to hang articles. In other embodiments, the front face of the insert may feature a layer of adhesive (described in further detail below). The projection 170 is disposed proximate the bottom edge 154 of the insert 150 in the depicted embodiment. It should be appreciated, however, that the projection 170 may be placed at any desired location on the front face 151, though typically such that it resides generally below the prong end 162 when the anchor 100 is assembled.

The anchor may be installed on a wallboard 190 (see FIG. 4) in assembled or disassembled form. In one exemplary method of hanging an object using the anchor assembly 100, the frame 110 is provided without the insert 150 received in the recess 130. The frame 110 is positioned at the desired location of the wall, and the user provides a generally horizontal force to front face 111 of opposing frame sections 120, 122 to drive the prongs 160 into the wallboard. The object to be hung is secured on the load bearing projection 170 (or otherwise adhered to the front 151 of the insert 150), and the insert is then slidably engaged with the recess 130. Alternatively, the object may be secured on the load bearing projection 170 after the insert 150 has been placed in the recess. To remove the anchor 100 from the wall, the user may remove the insert 150, and the use the bottom rail 148 to pull the frame 110 and prongs away from the wall surface.

As can be appreciated, the use of a multi-part anchor 100 allows the object to be easily removed from the wall without affecting the frame 110 or potentially damaging the wallboard. Accordingly, a user may also easily adjust the position of the insert relative to the object, allowing for fine adjustment in object location and orientation.

The anchor assembly 100 may be provided as a kit including a frame 110 and a plurality of inserts 150. The inserts 150 may vary in location and character (e.g., hook, shank, nail, decorative element) of the load bearing projection, or may vary in material composition. In another kit of the present disclosure, a plurality of frames may be provided with a plurality of inserts. The plurality of frames may vary amongst multiple characteristics including but not limited to recesses geometry, frame geometry, and prong geometry. Each of the plurality of frames may be adaptable for use with one or more of the plurality of inserts. In this way, the anchor 100 may serve as a universal mounting apparatus for a variety of objects.

In presently preferred implementations, the frame 110 and the insert 150 are made of a metal material, however, it can be appreciated that other suitable materials can be used. Each of the frame 110 and insert 150 are typically made from a resilient metal or metal alloy, such as stainless steel, titanium, cobalt-chromium alloy (such as manufactured by Elgiloy Specialty Metals, Elgin, Ill.), or a shape-memory alloy such as an alloy of nickel and titanium (e.g., Nitinol). Preferably, the frame 110 and insert 150 are sufficiently resilient so that the shape of the frame 110 and insert 150 when relaxed does not significantly change during the course of mounting an object. As another option, the frame 110 and insert 150 could be made from any other resilient material known to one skilled in the art, such as a flexible polymer or composite material. Moreover, although the anchor assembly 100 is specifically discussed as mountable on a wall of gypsum wallboard, it can be utilized with walls of other materials or to secure an object to something other than a wall.

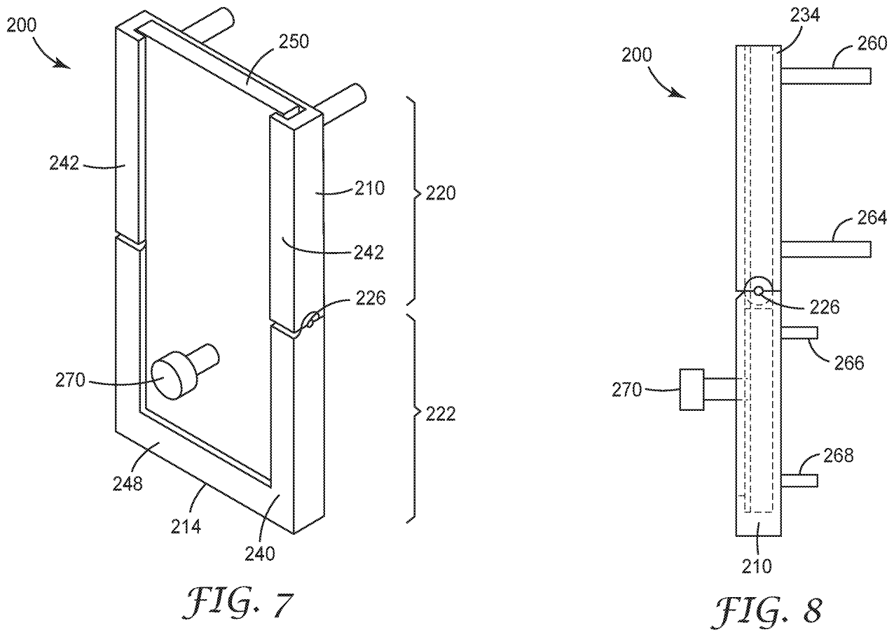

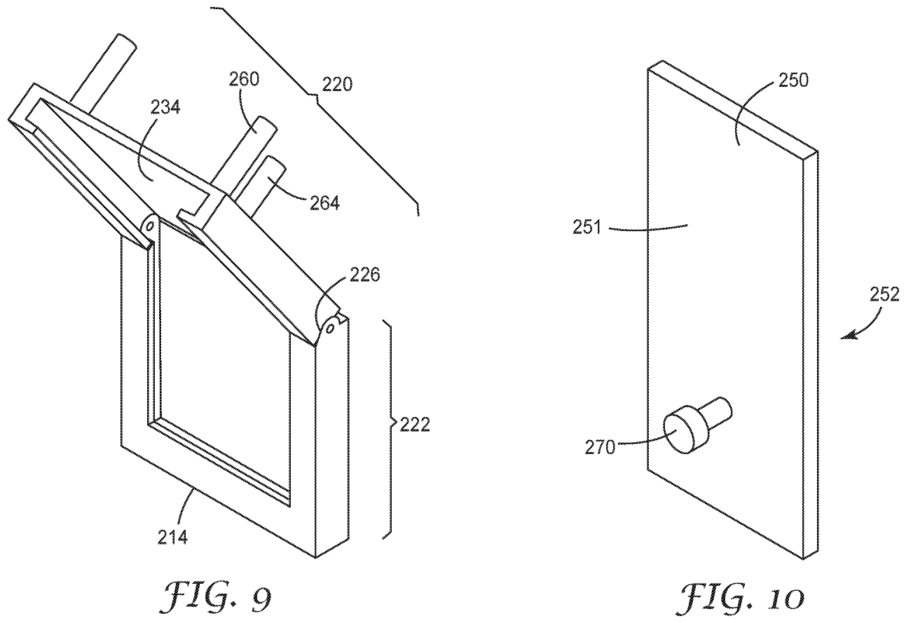

Turning to FIGS. 7-10, another embodiment of a wall anchor assembly 200 according to the present disclosure is depicted. Wall anchor 200 includes a frame 210 and an insert 250. The frame 210 includes a guide 240 including opposing rails 242 to form a recess 230. The recess 230 includes a continuous back plate 234, such that a portion of the frame 210 is disposed between the insert 250 and wall when the anchor 200 is assembled. The insert 250 includes a load bearing projection 270 and is dimensioned to slidably engage the guide 240. It is to be understood that many other aspects of anchor 200 may have similar form and function to those described with respect to anchor 100 and these need not be repeated.

The frame 210 includes an upper section 220 pivotally joined to a lower section 222 by a hinge segment 226. The hinge segment 226 allows for the upper section 220 to rotate relative to the lower section 222, and vice versa. The hinge segment 226 may be created by a single hinge pin extending some portion or all of the width of the frame, or a may be formed from a flexible segment of material. In presently preferred implementations, the hinge segment 226 is located proximate the middle of the frame 210. It is also contemplated that the frame 210 can be provided without a hinge segment or other pivotable mechanism.

The upper section 220 includes two pairs of spaced apart prongs 260, 264, while the lower section 222 also includes its own pair 266, 268. The prong pairs 260 and 264 are position adjacent the top and bottom edges of the upper section 220, respectively, and the prong pairs 266 and 268 are positioned adjacent the top and bottom edges of the lower section 222. Each prong pair 260, 264, 266, 268 extends outward from the back surface of the respective section at a substantially orthogonal angle. Fewer prongs or prong pairs may also be used with the exemplary anchor 200, but the plurality of insertion points can improve the stability of the frame 210 during installation, use, and removal.

To use anchor 200, a user selects the desired position on the wall to support an object. Next, pressure is applied horizontally to the lower section 222. This pressure forces the prong pairs 266, 268 into the wallboard. The pressure is applied continuously until the prongs penetrate the wallboard completely and the lower section 222 is flush with the vertical surface of the wall.

While the lower section 222 is held securely to the wall, force is applied in direction orthogonal to the front face 211 of the upper section 222. The orthogonal force applied results in the upper section 222 rotating around the hinge connection 226 due to the fixed location of the lower section 222. The rotation of the upper section 222 continues until the outer end of the prong pairs 260, 264 penetrate the wallboard. Further rotation results in the remaining length of the prong being driven into the wallboard. The object to be hung is secured on the load bearing projection 270, and the insert 250 is then slidably engaged with the guide 240 towards the bottom edge 214 of the frame 210. Alternatively, the object may be secured on the load bearing projection 270 after the insert 250 has been secured in the guide 240. Full receipt of the insert 250 in the guide 240 prevents further rotation about the hinge segment 226, thereby guarding against undesired removal of the prongs 260, 264 and the potential failure of the wallboard.

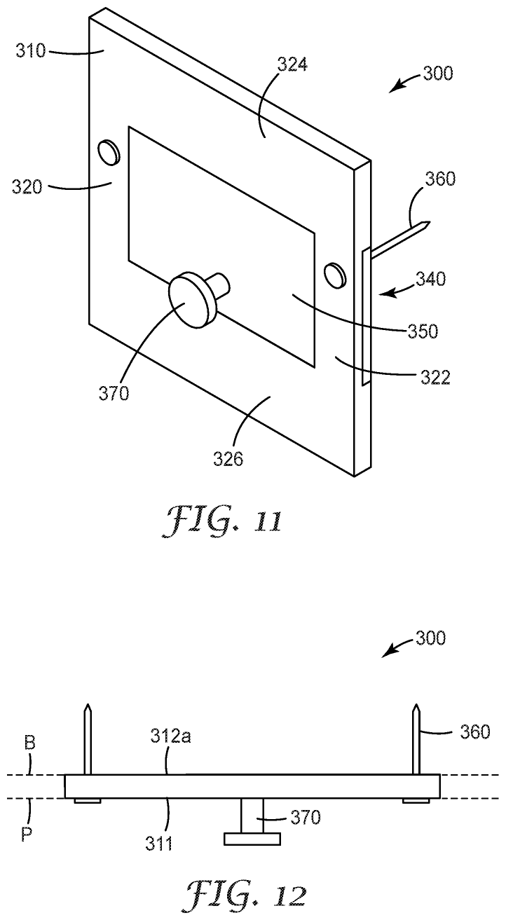

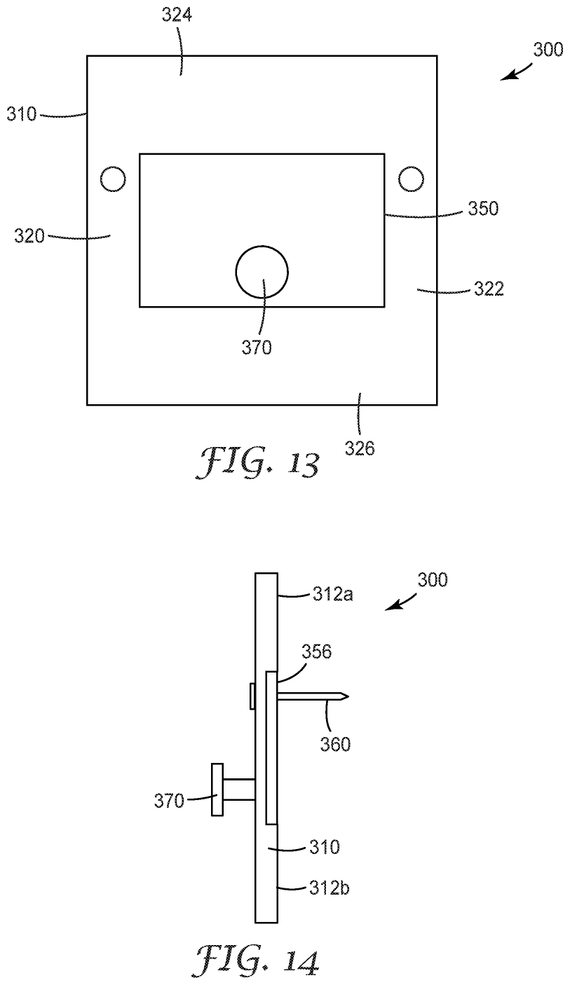

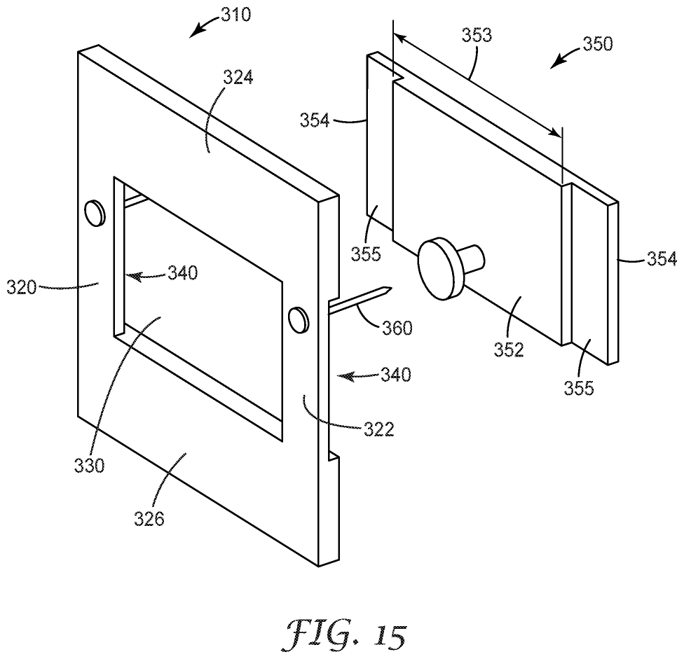

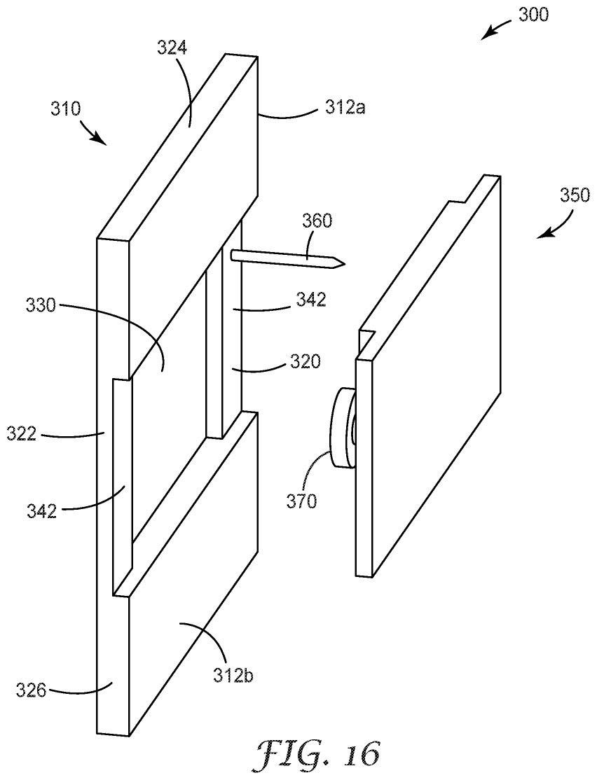

Yet another embodiment of a wall anchor 300 according to the present disclosure is depicted in FIGS. 11-16. The wall anchor 300 includes a frame 310 and an insert plate 350. The frame 310 further includes a closed recess 330 surrounded by a first frame side section 320, a second frame side section 322, a frame top section 326, and a frame bottom section 328. The interior edges of the frame sections 320, 322, 324, and 326 cooperate to define the perimeter of the recess 330. The frame includes a front surface 311, a back surface 312a of the top section 324, and a back surface 312b of the bottom section 326. Both the front 311 and back surfaces 312a, 312b are substantially planar, with the front surface 311 residing in a frame plane “P” and the back surfaces 312a, 312b residing in a frame plane “B”. It is to be understood that many other aspects of anchor 300 may have similar form and function to those described with respect to anchors 100 and 200, and these need not be repeated.

Each frame side section 320 and 322 features both a reduced thickness in the direction of the wall (i.e., the z-direction) and a reduced width (i.e., in the x-direction) as compared to frame top section 324 and frame bottom section 326. The reduced thickness results in a pair of grooves 340 on either side of the recess 330. The grooves 340 extend at least the length of the recess 330 and include a groove surface 342 residing in a plane parallel to the frame plane “B”. Prongs 360 extend outwardly from the groove surface 342 and are disposed proximate the top section 324.

The insert 350 includes a central region 352 having a load bearing projection 370 and opposing ledges 354 disposed on either side of the central region 352. The central region 352 is dimensioned to be matingly received in the recess 330, with a width 353 larger than the width of either ledge 354. While depicted a having a larger width in the x-direction, it is also contemplated that one or both ledges 353 may be larger in width than the central section, and that the ledges 354 may be oriented above and below the central regions 352.

Each ledge 354 has a reduced thickness in the wall direction compared to the central region 352, and includes a front surface 355 designed engage a groove surface 342 of the frame 310 when the anchor 300 is assembled. In some embodiments, one or both ledges include a width less than the width of the groove surface 342, allowing the prongs 360 to straddle the full width of the insert 350. In other embodiments (not depicted), one or both of the ledges can include a bore or other through-hole positioned to receive one of the pair of prongs 360 on frame 310.

A back surface 356 of the insert 350 can include an adhesive construction for temporarily securing the insert 350 to a wall surface. For example, the back surface may be coupled to a Command™ Adhesive Strip or a Command™ Picture Hanging Strip, both available from 3M Company. In some embodiments, the adhesive construction can include a pressure sensitive adhesive and a backing, while in other embodiments the adhesive construction includes only a continuous or discontinuous layer of pressure sensitive adhesive. A general description of useful pressure sensitive adhesives may be found in the Encyclopedia of Polymer Science and Engineering, Vol. 13, Wiley-Interscience Publishers (New York, 1988). Additional description of useful pressure-sensitive adhesives may be found in the Encyclopedia of Polymer Science and Technology, Vol. 1, Interscience Publishers (New York, 1964). Pressure sensitive adhesive compositions are well known to those of ordinary skill in the art to possess properties including the following: (1) tack, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. Suitable PSAs may be based on crosslinked or non-crosslinked (meth)acrylics, rubbers, thermoplastic elastomers, silicones, polyurethanes, and the like, and may include tackifiers in order to provide the desired tac, as well as other additives. In some embodiments, the PSA is based on a (meth)acrylic PSA or at least one poly(meth)acrylate, where (meth)acrylate refers to both acrylate and methacrylate groups. In some embodiments, the PSA is an olefin block copolymer based adhesive.

The adhesive construction used on the insert 350 maybe peelable or stretch releasable. In embodiments featuring a stretch releasable construction, the construction can be removed from a surface by stretching it at an angle of less than 35°. In embodiments featuring a peel-releasable construction, the adhesive can be removed from a wall surface by stretching it an angle of 35° or greater. In some embodiments, the releasable adhesive may be removed by a combination of stretch and peel-release mechanisms.

An insert 350 featuring one or more stretch release adhesive constructions can include, for example, any of the adhesives and constructions described in any of the following patents: U.S. Pat. No. 5,516,581 (Kreckel et al.); U.S. Pat. No. 6,231,962 (Bries et al.); U.S. Pat. No. 7,078,093 (Sheridan et al.); and U.S. Pat. No. 6,395,389 (Lühmann et al.), all of which are incorporated by reference herein in their entirety.

An insert 350 featuring one or more peelable adhesive constructions can include, for example, any of the adhesives and constructions described in any of the following patent applications: International Publication Nos. 2015/035556, 2015/035960, U.S. Pat. No. 9,894,931, and PCT Application Nos. US2017/015163 and US2017/014733, all of which are incorporated herein in their entirety.

The adhesive construction may further include one or more release liners. The release liner can be, for example, on either or both of major surfaces of the adhesive layers. The release liner protects the adhesive during manufacturing, transit, and before use. When the user desires to use the adhesive construction, the user can peel or remove the release liner to expose the adhesive. Examples of suitable liners include paper, e.g., kraft paper, or polymeric films, e.g., polyethylene, polypropylene or polyester.

The use of a removable adhesive on the insert 350 allows for a user to adjust the position of the insert 350 before committing to the location of the anchor 300 or otherwise puncturing the wall. To use anchor assembly 300, a user first removes any release liner from the adhesive construction on the insert. The insert 350 is then placed at the desired location and secured to the wall surface using finger pressure in the direction of the wall. Advantageously and depending on, e.g., the shear strength of the adhesive constructions used, the object to mounted may be hung from the load bearing projection at this point to confirm desired location and orientation. Once the user is satisfied with the location of the insert 350, the frame 310 is placed over the insert 350 so that recess 330 is generally aligned with the central region 352. Finger pressure in the direction of the wall surface on the side sections 320, 322 may be used to drive prongs 360 into the wallboard. The user may apply pressure until the central section 352 is received in the recess 330 and the ledge front surfaces 355 contact the groove surfaces 342. Contact between the front surface and the groove surface may provide an audible “click”, alerting the user that the anchor 300 is suitably assembled. Once finished, the groove surfaces 342 on the frame 310 provide a rotational stop on the insert 350, such that a moment created on the insert by an object on the loading bearing projection 370 does not cause the insert 350 to debond from the wall surface.

The wall anchors described herein may be used to mount various items and objects to surfaces such as painted drywall, plaster, concrete, glass, ceramic, fiberglass, metal or plastic. Items that can be mounted include, but are not limited to, wall hangings, organizers, holders, baskets, containers, decorations (e.g., holiday decorations), calendars, posters, dispensers, wire clips, guitars, and carrying handles.

The patents, patent documents, and patent applications cited herein are incorporated by reference in their entirety as if each were individually incorporated by reference. It will be apparent to those of ordinary skill in the art that various changes and modifications may be made without deviating from the inventing concepts set from above. Thus, the scope of the present disclosure should not be limited to the structures described herein. Those having skill in the art will appreciate that many changes may be made to the details of the above-described embodiments and implementations without departing from the underlying principles thereof Further, various modifications and alterations of the present invention will become apparent to those skilled in the art without departing from the spirit and scope of the invention. The scope of the present application should, therefore, be determined only by the following claims and equivalents thereof.

1. A wall anchor assembly for attaching to a mounting surface, the assembly comprising:
a frame plate having a front surface and a back surface; the frame plate including a recess;
a first prong extending outwardly from the back surface of the frame; and
an insert receivable within the recess, the insert including a load bearing structure extending a least partially in the opposite direction of the prong.

2. The assembly of claim 1, and further comprising a second prong extending outwardly from the back surface of the base plate.

3. The assembly of claim 2, wherein the first and second prongs extend from the back surface at a substantially orthogonal angle.

4. The assembly of claim 1, wherein the prong is orthogonal relative to the back plate.

5. The assembly of claim 1, wherein the recess includes a guide rail on or defined by the frame plate.

6. The assembly of claim 1, wherein the recess is rectangular or Y-shaped.

7. The assembly of claim 1, wherein the insert is disposed between the back surface of the base plate and the mounting surface when the insert is received in the guide.

8. The assembly of claim 1, wherein the frame plate includes an upper section and a lower section, and wherein the upper region is pivotable relative to the lower region.

9. The assembly of claim 8, wherein the insert arrests the pivoting of the frame plate.

10. The assembly of claim 8 or 9, wherein the frame plate includes one of a hinge and a flexible material.

11. A wall anchor assembly for attaching to a mounting surface, the assembly comprising:
an insert plate having a front surface and an opposing back surface and defining a perimeter, the back surface including an adhesive construction; and
a frame dimensioned to surround the perimeter of the base plate, wherein the frame includes a recess, and wherein a portion of the insert plate is dimensioned to fit within the recess.

12. The assembly of claim 11, wherein the adhesive construction is a stretch-releasable adhesive construction.

13. The assembly of claim 11, wherein the adhesive construction is a peel releasable adhesive construction.

14. The assembly of claim 11, wherein the frame includes a prong extending outward at an angle relative to the frame.

15. The assembly of claim 11, wherein the prong is substantially orthogonal to the frame.

16. The assembly of claim 11, wherein the frame includes a recess, and wherein a portion of the insert plate is dimensioned to fit within the recess.

17. The assembly of claim 16, wherein the frame includes a top section, a bottom section, and two opposing side sections, and wherein the top, bottom, and side sections define the recess on an interior of the frame.

18. The assembly of claim 16, wherein the side sections have a reduced thickness relative to the top and bottom sections, and wherein a back surface of the each of the side sections defines a guide surface.

19. The assembly of claim 11, wherein the insert plate includes a central region and a pair of ledges, one ledge arranged on each side of the central region, and wherein each ledge has a reduced thickness in comparison to the central region.

20. The assembly of claim 11, wherein the side sections have a reduced thickness relative to the top and bottom sections, and wherein a back surface of each of the side sections define a guide surface, wherein the insert plate includes a central region and a pair of ledges, one ledge arranged on each side of the central region, and wherein each ledge has a reduced thickness in comparison to the central region, wherein the guide surface contacts a front surface of the ledge when the central region is received in the recess.
